(19) United States
(12) Patent Application Publication
(10) Pub. No.: US 2025/0335127 A1
(43) Pub. Date: Oct. 30, 2025

(54) INFORMATION PROCESSING DEVICE AND INFORMATION PROCESSING METHODS

(71) Applicant: Renesas Electronics Corporation, Tokyo (JP)

(72) Inventor: Yuji OBAYASHI, Tokyo (JP)

(21) Appl. No.: 19/075,919

(22) Filed: Mar. 11, 2025

(30) Foreign Application Priority Data
Apr. 24, 2024 (JP) 2024-070321

(51) Int. Cl. G06F 3/06

(52) U.S. Cl. CPC G06F 3/0659; G06F 3/0604; G06F 3/0683

(57) ABSTRACT

An information processing device is provided that synchronizes the progress of data transferring unit with the timing of processing by calculation processing unit. The information processing device comprises an external bus connecting unit for connecting data transferring unit, a local memory, and a command list processing unit to the external memory, the data transferring unit for transferring data, which are conditions for calculation stored in the external memory, to the local memory, the local memory for storing data and a list of commands, the command list processing unit for generating commands that cause the calculation processing unit to execute calculations, by reading the list of commands from the local memory while data is being transferred from the external memory to the local memory, and the calculation processing unit for executing calculations and processing data.

### CROSS-REFERENCE TO RELATED APPLICATIONS

The disclosure of Japanese Patent Application No. 2024-070321 filed on Apr. 24, 2024, including the specification, drawings and abstract is incorporated herein by reference in its entirety.

### BACKGROUND

This disclosure relates to an information processing device and an information processing method.

There are disclosed techniques listed below.

[Patent Document 1] Japanese Unexamined Patent Application Publication No. 2017-97066

Patent Document 1 describes an image processing device that improves the data processing speed of images.

### SUMMARY

However, the image processing device described in Patent Document 1 transfers data from the main memory to the local memory but does not describe a method for synchronizing the progress of the transfer with the timing of the processing by the calculation processing unit. Therefore, an object of this disclosure is to provide an information processing device that synchronizes the progress of the data transferring unit with the timing of the processing by the calculation processing unit.

Other objects and novel features will become apparent from the description of this specification and the accompanying drawings.

According to an embodiment, the information processing device is an information processing device that reads a list of commands from the local memory and generates a command to execute a calculation by the calculation processing unit while transferring data from the external memory to the local memory.

According to the embodiment, it is possible to synchronize the progress of the data transferring unit with the timing of the processing by the calculation processing unit and improve processing performance.

### BRIEF DESCRIPTION OF THE DRAWINGS

FIG. 1 is a block diagram showing the configuration of a related information processing device.

FIG. 2 is a diagram illustrating an example of performance improvement due to increased transfer size and increased startup wait time.

FIG. 3 is a block diagram showing the configuration of an information processing device according to the first embodiment.

FIG. 4 is a diagram illustrating an example of performance improvement by the information processing device according to the first embodiment.

FIG. 5 is a diagram showing the configuration of the functional blocks of the information processing device according to the first embodiment.

FIG. 6 is a detailed diagram of the functional blocks of the command list processing unit according to the first embodiment.

FIG. 7 is a detailed diagram of the functional blocks of the data transferring unit according to the first embodiment.

FIG. 8 is a block diagram showing the configuration of an information processing device according to the second embodiment.

FIG. 9 is a block diagram showing the configuration of an information processing device according to the third embodiment.

FIG. 10 is a block diagram showing the configuration of an information processing device according to the fourth embodiment.

### DETAILED DESCRIPTION

For clarity of explanation, the following description and drawings are appropriately omitted and simplified. Furthermore, each element described in the drawings as functional blocks performing various processes can be realized, for example, in hardware by a CPU (Central Processing Unit), memory, and other circuits, and in software by programs loaded into memory. Therefore, it is understood that these functional blocks can be realized by hardware, software operating on hardware, or a combination thereof. In the drawings, the same elements are denoted by the same reference numerals, and a repetitive description thereof is omitted as necessary.

Also, the programs described above may be stored and provided to a computer using various types of non-transitory computer readable media. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory, a CD-R, a CD-R/W, solid-state memories (e.g., masked ROM, PROM (Programmable ROM), EPROM (Erasable PROM, flash ROM, RAM (Random Access Memory)). The programs may also be supplied to the computer by various types of transitory computer-readable media. Examples of transitory computer-readable media include electrical signals, optical signals, and electromagnetic waves. The transitory computer readable medium may provide the program to the computer via wired or wireless communication paths, such as electrical wires and optical fibers.

### (The Information Processing Device)

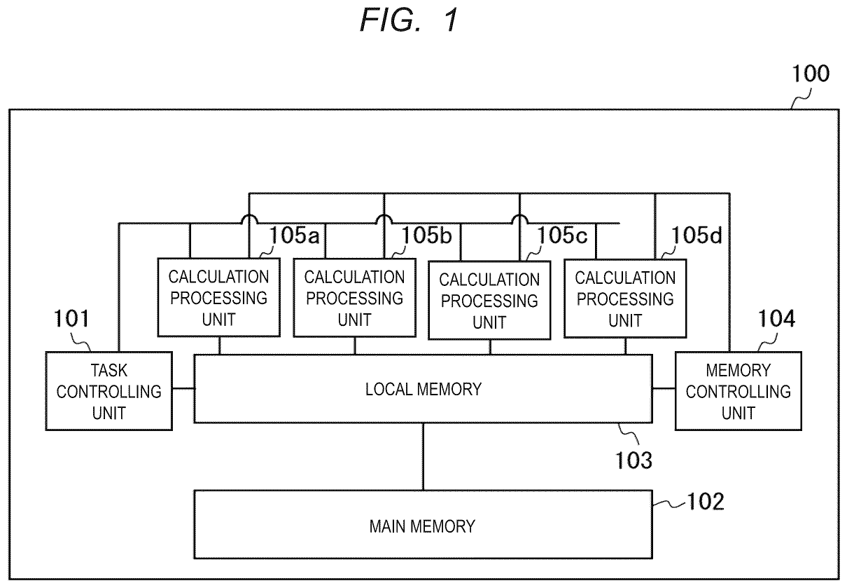

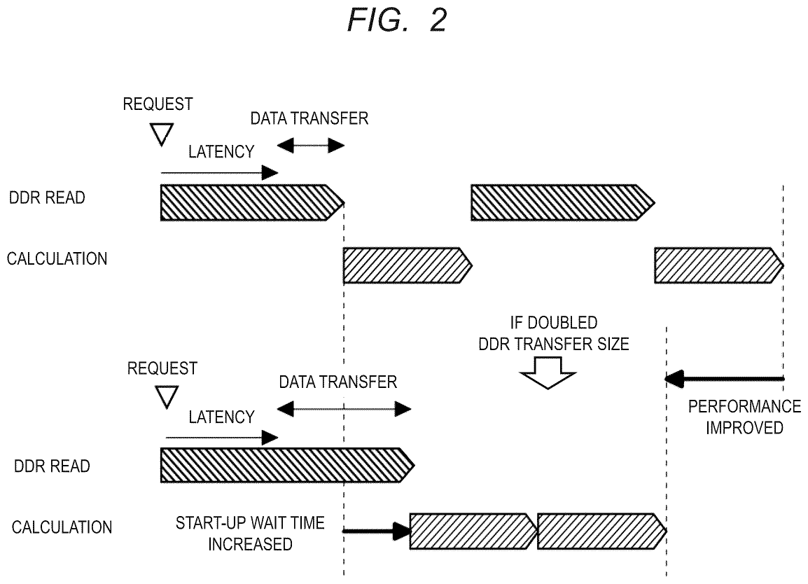

FIG. 1 is a block diagram showing the configuration of a related information processing device. FIG. 2 is a diagram illustrating an example of performance improvement due to increased transfer size and increased startup wait time. Referring to FIGS. 1 and 2, the related information processing device will be described.

In order to efficiently execute processes such as object detection and segmentation, which are necessary for autonomous driving, on an in-vehicle SoC (System on Chip), it is common practice to equip the SoC with an accelerator for AI processing. As the scale of SoC (System on Chip) increases, the speed difference between external memory such as DDRx-SDRAM (Double Data Rate−Synchronous Dynamic Random Access Memory) and the internal memory of SoC is becoming larger. Therefore, to improve the performance of information processing devices, it is necessary to enhance the efficiency of data transfer with external memory.

When a read from external memory becomes necessary, transferring as much data as possible at once from DDRx-SDRAM improves the efficiency of memory bandwidth usage and is expected to enhance performance. However, the AI accelerator starts processing only after the completion of data transfer to the internal memory, resulting in a long wait time before the processing begins. Similarly, the same problem exists for data transfers between the L2 memory and L1 memory of the AI accelerator.

As shown in FIG. 1, the related information processing device 100 includes a memory controlling unit 104, a local memory 103, a main memory 102, a task controlling unit 101, and calculation processing devices 105a to 105d.

The memory controlling unit 104 transfers the necessary amount of data from the main memory 102 to the local memory 103 with high-speed. The calculation processing units 105a to 105d access the local memory 103 to perform the necessary image processing. If there is an overlap in the data referenced by each of calculation processing units 105a to 105d, the memory controlling unit 104 reuses the overlapping parts. Thus, the memory controlling unit 104 reduces the amount of data transferred from the main memory 102.

The memory controlling unit 104 transfers data from the main memory 102 to the local memory 103, but it does not synchronize the progress of the transfer with the timing of the processing by the calculation processing units 105a to 105d. Therefore, the calculation processing devices 105a to 105d start processing after all the data to be used for the task assigned by the task controlling unit 101 has been transferred to the local memory 103.

As shown in FIG. 2, in processing such as image recognition, when reading input tensors and weights of neural networks from external memory, doubling the transfer size eliminates one latency time, thereby improving overall performance. However, since the related information processing device starts processing after waiting for the completion of data transfer to the internal memory, the data transfer time is extended, and the startup wait time increases.

### The Information Processing Device According to the First Embodiment

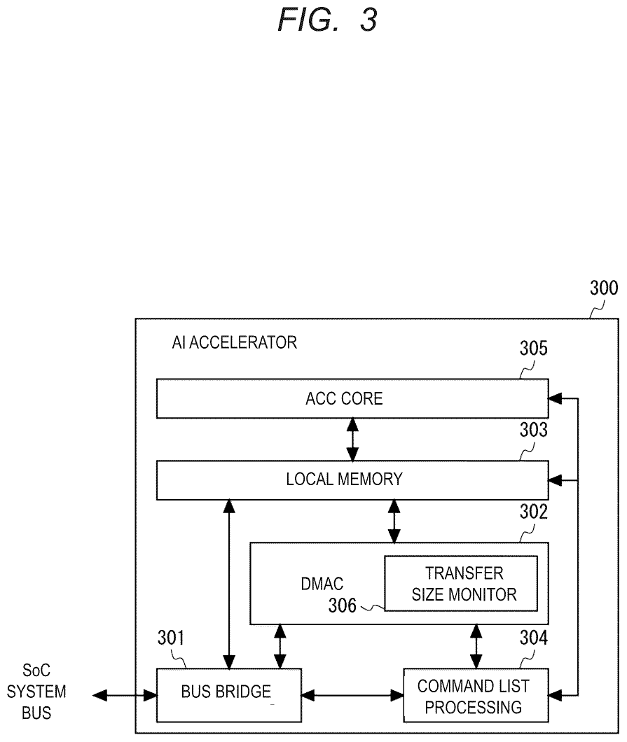

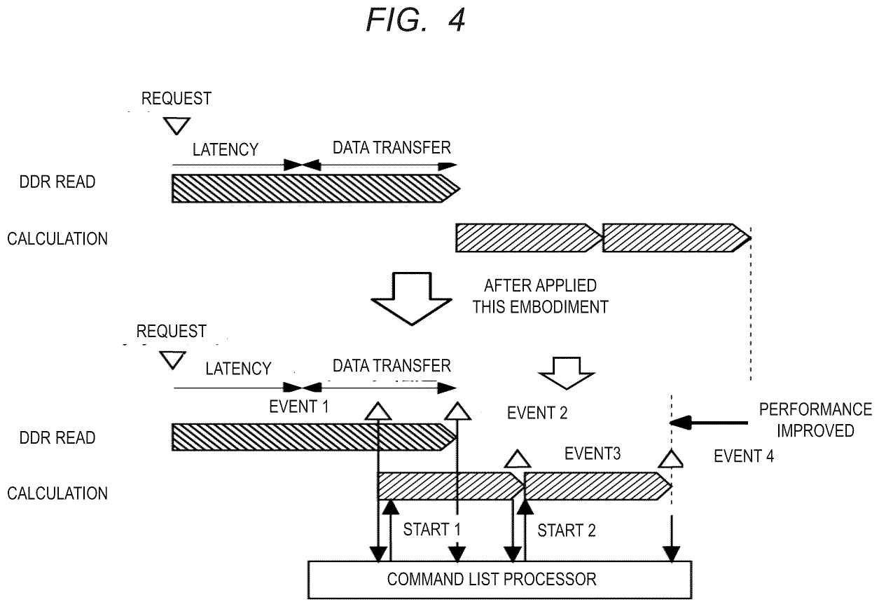

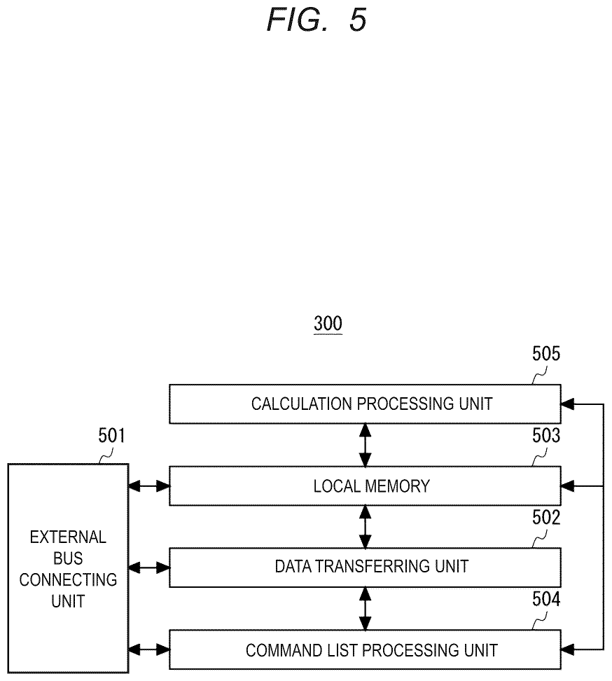

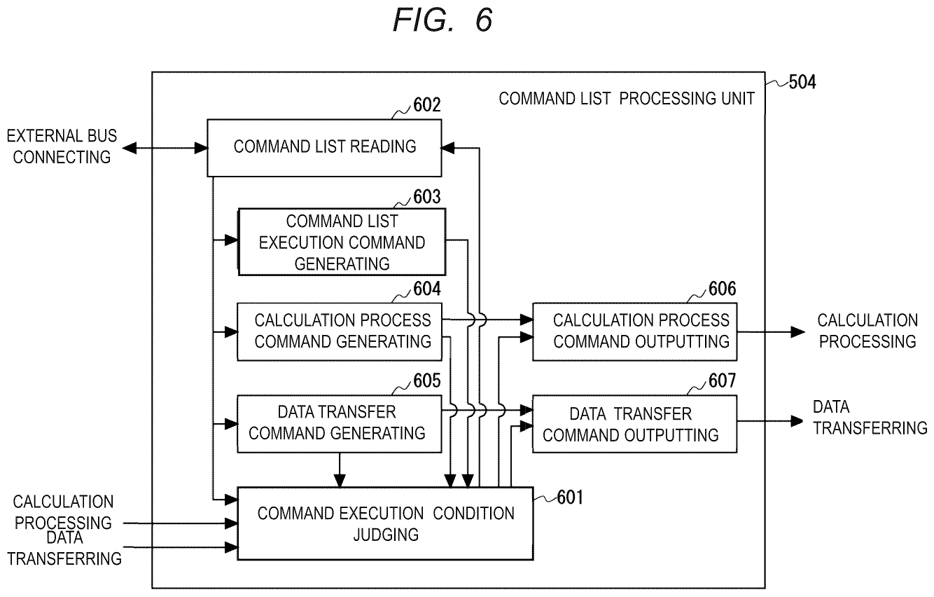

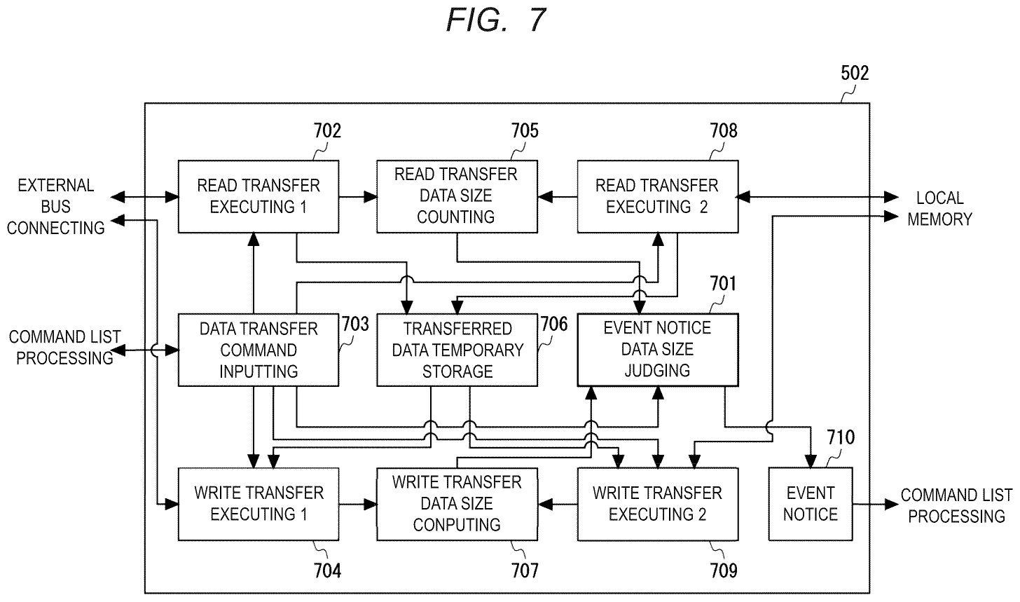

FIG. 3 is a block diagram showing the configuration of the information processing device according to the first embodiment. FIG. 4 is a diagram showing an example of performance improvement by the information processing device according to the first embodiment. FIG. 5 is a diagram showing the configuration of the functional blocks of the information processing device according to the first embodiment. FIG. 6 is a detailed diagram of the functional blocks of the command list processing unit according to the first embodiment. FIG. 7 is a detailed diagram of the functional blocks of the data transferring unit according to the first embodiment. The information processing device according to the first embodiment will be described with reference to FIGS. 3 to 7.

As shown in FIG. 3, the information processing device 300 according to the first embodiment is, for example, an AI (Artificial Intelligence) accelerator. The AI accelerator includes an Acc core 305 as calculation processing unit, a local memory 303, a DMAC (Direct Memory Access Controller) 302, a transfer size monitoring unit 306, a command list processing unit 304, and a bus bridge 301.

The information processing device 300 adds a transfer size monitoring unit 306 to the DMAC 302 and notifies an event to the command list processing unit 304 each time the transfer of the set size is completed. If the Acc core 305 is available, the command list processing unit 304 activates the Acc core 305; if not available, it waits until the Acc core 305 becomes available and then activates the Acc core 305.

As shown in the upper figure of FIG. 4, in the related information processing device, it took time to start the calculation process from the request. Therefore, as shown in the lower figure of FIG. 4, the command list processing unit 304 receives an event each time the set size of transfer is completed, and initiates the computing device, enabling the initiation of the calculation processing unit during data transfer. Thus, compared to the upper figure of FIG. 4, the lower figure of FIG. 4 shows a reduction in overall processing time and an improvement in performance.

As shown in FIG. 5, the information processing device 300 according to the first embodiment includes a calculation processing unit 505, a local memory 503, a data transferring unit 502, a command list processing unit 504, and an external bus connecting unit 501.

The calculation processing unit 505 executes calculation and process of data. The calculation processing unit 505 is, for example, the Acc core 305. The calculation processing unit 505 performs a calculation process necessary for AI processing, etc. The calculation process to be executed is specified by commands sent from the command list processing unit 504. The calculation processing unit 505 reads data for calculation and writes results to the local memory 503. Furthermore, when the processing is completed, the calculation processing unit 505 notifies the command list processing unit 504 of the events.

The local memory 503 stores data and a list of commands. The local memory 503 is, for example, the local memory 303. The local memory 503 is a memory that can be accessed quickly by the calculation processing unit 505. The local memory 503 is also accessible from the data transferring unit 502, the external bus connecting unit 501, and the command list processing unit 504.

The data transferring unit 502 transfers data, which are the conditions for calculating stored in the external memory, to the local memory 503. The data transferring unit 502 is, for example, the DMAC 302. The data transferring unit 502 reads data for use by the calculation processing units 505 from external memory connected to the SoC via the external bus connecting unit 501, such as DDRx-SDRAM, based on commands from the command list processing unit 504. Moreover, the data transferring unit 502 writes the processing results of the calculation processing unit 505 to the external memory connected to the SoC.

The data transferring unit 502 includes, for example, a transfer size monitoring unit 306. The transfer size monitoring unit 306 is part of the data transferring unit 502. The transfer size monitoring unit 306 notifies the command list processing unit 504 of an event each time the data transferring unit 502 completes a transfer of a specified size.

The external bus connecting unit 501 connects the data transferring unit 502, the local memory 503, and the command list processing unit 504 to the external memory. The external bus connecting unit 501 is, for example, the bus bridge 301. The external bus connection unit 501 accesses the local memory 503, the data transferring unit 502, and the command list processing unit 504 in response to access requests from the SoC system bus. Furthermore, the external bus connecting unit 501 accesses the SoC system bus in response to access requests from the data transferring unit 502 and the command list processing unit 504.

The command list processing unit 504 reads a list of commands from the local memory 503 and generates commands to execute calculations by the calculation processing unit 505 while transferring data from the external memory to the local memory 503. The command list processing unit 504 is, for example, a command list processor 304. The command list processing unit 504 reads and executes a list of commands stored in the local memory 503. The command list processing unit 504 sends commands that determine their operations to the calculation processing unit 505 and the data transferring unit 502. Furthermore, the command list processing unit 504 receives events from the calculation processing unit 505 and the data transferring unit 502 and uses them for condition judgment in command generation.

FIG. 6 shows a block diagram of the detailed functions of the command list processing unit 504 of FIG. 5. As shown in FIG. 6, the command list processing unit 504 includes a command execution condition judging unit 601, a command list reading unit 602, a command list execution control command generating unit 603, a calculation processing command generating unit 604, a data transfer command generating unit 605, a calculation processing command outputting unit 606, and a data transfer command outputting unit 607.

The command execution condition judging unit 601 judges the necessary conditions for each command to be judged and instructs the calculation processing command outputting unit 606 and the data transfer command outputting unit 607 to output the target command. For example, the command execution condition judging unit 601 instructs the calculation processing command outputting unit 606 to issue a command to execute the calculation processing when an event indicating the completion of a certain amount of data transfer from the data transferring unit 502 is notified. The command execution condition judging unit 601 instructs the data transfer command outputting unit 607 to issue a command for data transfer when an event indicating the completion of processing from the calculation processing unit 505 is notified.

Furthermore, the command execution condition judging unit 601 instructs the command list reading unit 602 to change the command list reading operation in the case of a command list execution control command. The change in operation is, for example, a change in the command list reading address.

FIG. 7 shows a block diagram of the detailed functions of the data transferring unit 502 in FIG. 5. As shown in FIG. 7, the data transferring unit 502 includes an event notice data size judging unit 701, a read transfer executing unit 1 702 at external bus side, a data transfer command inputting unit 703, a write transfer executing unit 1 704 at external bus side, a read transfer data size counting unit 705, a transferred data temporary storage 706, a write transfer data size counting unit 707, a read transfer executing unit 2 708 at local memory side, a write transfer executing unit 2 709 at local memory side, and an event notice unit 710.

The read transfer data size counting unit 705 measures the amount of data from the external bus connecting unit 501. The event notice data size determining unit 701 acquires the amount of data from the read transfer data size counting unit 705 and, upon determining that a certain amount of data has been reached, the event notice unit 710 notifies an event to the command list processing unit 504.

Thus, the event notice data size judging unit 701 observes the data transfer completion size on either the read side or the write side according to specified conditions. When the current transfer completion size meets the event notification conditions previously entered as part of the data transfer command, it notifies the command list processing unit 504 using the event notice unit 710.

In the first embodiment, the transfer size monitoring unit 306 is incorporated into a DMAC 302 for transferring data from an external memory to a local memory 303 via an SoC system bus and a bus bridge 301. Without waiting for the completion of a series of transfers by the DMAC 302, the transfer size monitoring unit 306 detects that the data required by the Acc core 305 for one unit of processing has been transferred to the local memory 303 and notifies the command list processing unit 304. The command list processing unit 304 can instruct the Acc core 305 to start processing.

Thus, the technology of the first embodiment can start processing the Acc core 305 more quickly compared to related technologies. For instance, when processing two units with the Acc core 305, the DMAC 302 can advance the start of processing for the Acc core 305 by the time it takes to complete the transfer of the first unit and then the remaining unit. By advancing in this manner, it is possible to reduce the overall processing time by an amount corresponding to whichever is shorter: the processing time for one unit of the Acc core 305 or the time to complete the transfer of the remaining unit to local memory 303 after the transfer of the first unit is completed, thereby improving processing performance.

With the above configuration, an information processing device and an information processing method are provided, which synchronize the progress of the data transferring unit and the timing of the processing of the calculation processing unit.

### The Information Processing Device According to the Second Embodiment

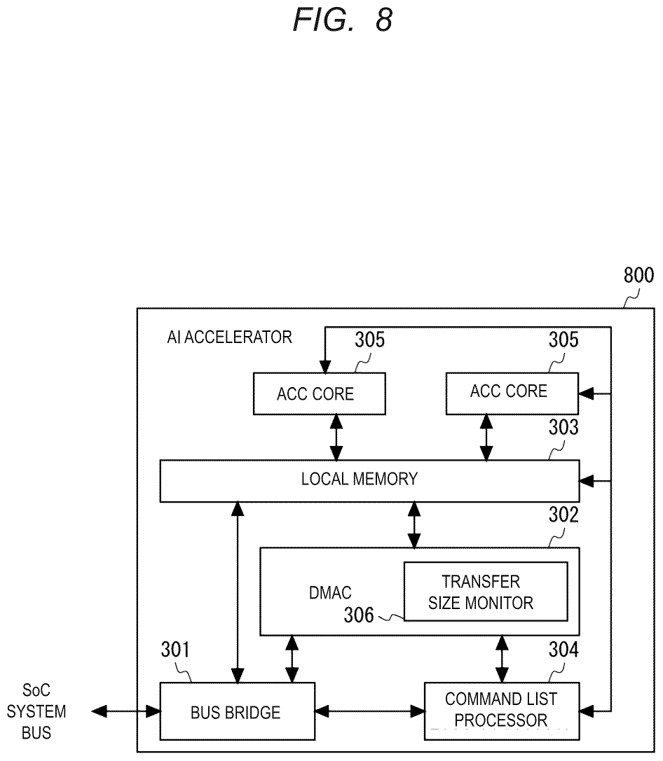

FIG. 8 is a block diagram showing the configuration of an information processing device according to the second embodiment. With reference to FIG. 8, the information processing device according to the second embodiment will now be described.

An information processing device 800 according to a second embodiment differs from an information processing device 300 according to a first embodiment in that it includes a plurality of Acc cores 305. As shown in FIG. 8, the information processing device 800 according to the second embodiment includes a plurality of Acc cores 305. That is, the calculation processing unit 505 of the information processing devices 800 are composed of multiple cores.

The command list processing unit 304 issues commands individually to each Acc core 305 and receives events individually. Therefore, the information processing device 800 can execute the calculation of another part of one process in another core while executing the calculation of one part of the process in one core. This allows for efficient utilization of multiple cores in processing.

### The Information Processing Device According to the Third Embodiment

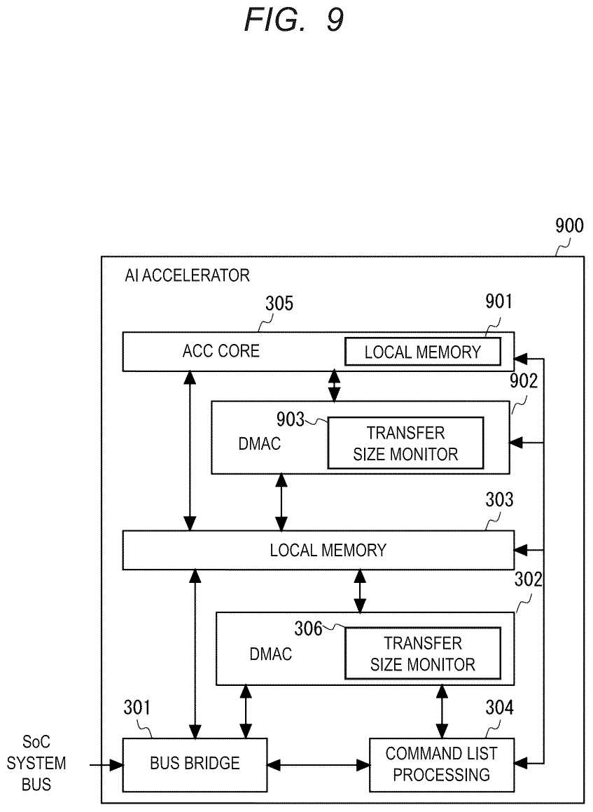

FIG. 9 is a block diagram showing the configuration of the information processing device according to the third embodiment.

The information processing device according to the third embodiment will be described with reference to FIG. 9.

The information processing device 900 according to the third embodiment differs from the information processing device 300 according to the first embodiment in that it includes a local memory 901 in the Acc core 305 and a DMAC 902 equipped with a transfer size monitoring unit 903 for data transfer between the local memory 303 and the local memory 901.

The local memory 901 is referred to as L1 memory, and the local memory 303 is referred to as L2 memory. The information processing device 900 includes a DMAC 902 for transferring between the L1 memory and the L2 memory and a transfer size monitoring unit 903, performing control similar to that of the first embodiment. That is, the calculation processing unit 505 includes a second local memory. Also, the DMAC 902, which is a second data transferring unit equipped with a second transfer size monitoring unit, the transfer size monitoring unit 903, detects the completion of the transfer of a unit of data that can be computed by the calculating processing unit 505 from the local memory 503 to the second local memory. At that time, the command list processing unit 504 generates a command to execute calculation by the calculation processing unit 505.

Thus, by hierarchizing the local memory, processing time can be shortened in a manner similar to that of the first embodiment for each hierarchy, resulting in a significant time reduction effect for the entire hierarchy.

### The Information Processing Device According to the Fourth Embodiment

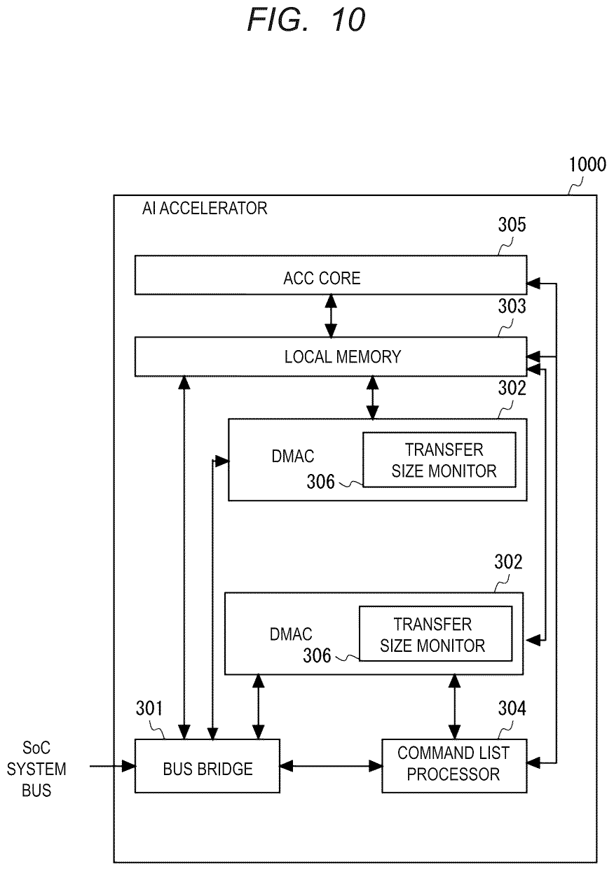

FIG. 10 is a block diagram showing the configuration of the information processing device according to the fourth embodiment. The information processing device according to the fourth embodiment will be described with reference to FIG. 10. The information processing device 1000 according to the fourth embodiment differs from the information processing device 300 according to the first embodiment in that it includes multiple DMACs 302 equipped with a transfer size monitoring unit 306.

That is, it includes multiple data transferring unit 502. Moreover, each of the multiple data transferring units 502 is equipped with a transfer size monitoring unit. The transfer size monitoring unit detects the completion of the transfer of a unit of data that can be computed by the calculating processing unit 505 from the external memory to the local memory 503. At that time, the command list processing unit 504 generates a command to execute calculation by the calculation processing unit 505.

The command list: processing unit 304 issues commands individually to each of the multiple DMACs 302 and receives events individually. This allows for the reduction of processing time by confirming the completion of the data transfer of the unit required for one processing for each input and activating the Acc core 305, even if the processing in the Acc core 305 uses multiple inputs for calculation.

### OTHER EMBODIMENTS

In addition to using the transfer size monitoring unit 306 of the first embodiment, a command list processing unit 304 may be utilized. A command list that includes a sequence of multiple transfer commands, which are divided to transfer sizes larger than the unit amount required for processing by the Acc core 305, for transfers between the external memory and the local memory 303, may be used. Furthermore, the bus bridge 301 is equipped with a function to concatenate multiple transfer requests of the same attribute (read/write, privilege level, optimization mode, etc.) for consecutive addresses from inside and convert them into a larger size transfer request before outputting to the external bus.

That is, the command list processing unit 504 rearranges and links multiple transfer commands, which transfer a size larger than one unit of data that the calculation processing unit 505 can calculate, into multiple transfer commands of the same attribute for consecutive addresses inside the local memory 503. The command list processing unit 504 requests the transfer of data to the external bus connection unit 501 by issuing a transfer command. The command list processing unit 504 generates a command to execute the calculation by the calculation processing unit 505 when the transfer of the required amount of data is completed in the local memory 503. In this way, the Acc core 305 can be activated when the required amount of data transfer is completed without waiting for the completion of the entire transfer, similar to when using the transfer size monitoring unit 306. In this case, the notification of the completion of each divided transfer command corresponds to the timing of the notification by the transfer size monitoring unit 306 of the first embodiment.

In addition to using the transfer size monitoring unit 306 of the first embodiment, a mechanism to determine the access range in the local memory 303 may be provided to grasp the progress of the transfer. The local memory 303 notifies the command list processing unit 304 of an event when a part of the data transfer is completed. That is, the local memory 503 is equipped with a mechanism to determine the access range. And, when the mechanism to determine the access range detects that the transfer of one unit of data that the calculation processing unit 505 can calculate from the external memory to the local memory 503 is completed, the command list processing unit 504 generates a command to execute the calculation by the calculation processing unit 505. In this way, the same effect as when installing the transfer size monitoring unit 306 in the DMAC 302 can be obtained.

The information processing device 300 related to the first embodiment may generate an event at the progress of a predetermined process other than at the end of the processing of the Acc core 305. In this way, the transfer of processed data by the DMAC 302 can be started before the completion of the processing of the Acc core 305. That is, the command list processing unit 504 generates a command to start the transfer of data being processed from the local memory 503 to the external memory during the calculation by the calculation processing unit 505. Therefore, after writing the processing results in the Acc core 305 to the local memory 303, the processing time to transfer data from the local memory 303 to the external memory by the DMAC can be reduced.

In the fourth embodiment, instead of equipping multiple DMACs 302, it is possible to specify two or more sets of source and destination combinations within a single DMAC 302 and perform the transfer of each set in a separately specified order. Also, in each set, the amount of data to be transferred when it is their turn is specified independently. That is, the data transferring unit 502 specifies two or more sets of data sources and destinations, performs the transfer of data for each set in divided and sequential order, and independently specifies the amount of data to be divided in each set. Thus, even if there is a difference in the amount of data in multiple inputs, as in the third embodiment, it prevents the reduction of the effect of shortening the processing time due to the uneven progress of the overall transfer. For example, when the image data of A is 500 MB and the image data of B is 250 MB, by transferring A in increments of 50 MB and B in increments of 25 MB, it is possible to prevent the progress of the transfer from becoming uneven.

Although the invention made by the inventor has been specifically described based on the embodiment, the present invention is not limited to the embodiment already described, and it is needless to say that various modifications can be made without departing from the gist thereof.

What is claimed is:

1. An information processing device comprising a data transferring unit, a local memory, a command list processing unit and an external bus connecting unit for connecting the data transferring unit, the local memory, and the command list processing unit to an external memory,
wherein the data transferring unit transfers data which are conditions of calculation stored in the external memory to the local memory,
wherein the local memory stores the data and a list of commands,
wherein the command list processing unit reads the list of commands from the local memory and generates a command to execute calculation by a calculation processing unit while transferring the data from the external memory to the local memory,
wherein the calculation processing unit executes the calculation and processing the data.

2. The information processing device according to claim 1,
wherein the data transferring unit includes a transfer size monitoring unit, and the command list processing unit generates a command to execute calculation by the calculation processing unit when the transfer size monitoring unit detects that the transfer of one unit of data, which can be calculated by the calculation processing unit, from the external memory to the local memory is completed.

3. The information processing device according to claim 1,
wherein the command list processing unit rearranges and links multiple transfer commands, which transfer a size of data larger than one unit that can be calculated by the calculation processing unit, into multiple transfer commands of the same attribute for consecutive addresses inside the local memory, requests the transfer of the data to the external bus connecting unit by issuing the transfer commands, and generates a command to execute calculation by the calculation processing unit when the transfer of the required amount of data to the local memory is completed.

4. The information processing device according to claim 1,
wherein the command list processing unit generates a command to start the transfer of the data being processed from the local memory to the external memory during the calculation by the calculation processing unit.

5. The information processing device according to claim 1,
wherein the calculation processing unit is composed of multiple cores, and while one core is executing a part of the calculation for one process, another core executes another part of the calculation for the one process.

6. The information processing device according to claim 1,
wherein the calculation processing unit includes a second local memory, and the command list processing unit includes a second data transferring unit equipped with a second transfer size monitoring unit, which generates a command to execute calculation by the calculation processing unit when it detects that the transfer of one unit of data, which can be computed by the calculation processing unit, from the local memory to the second local memory is completed.

7. The information processing device according to claim 1,
wherein the local memory includes a mechanism to determine the access range, and the command list processing unit generates a command to execute calculation by the calculation processing unit when the mechanism to determine the access range detects that the transfer of one unit of data, which can be computed by the calculation processing unit, from the external memory to the local memory is completed.

8. The information processing device according to claim 1 comprising multiple data transferring units,
wherein each of the multiple data transferring units includes the transfer size monitoring unit, wherein command list processing unit generates a command to execute calculation by the calculation processing unit when the transfer size monitoring unit detects that the transfer of a unit of data, which can be calculated by the calculation processing unit, from the external memory to the local memory is complete.

9. The information processing device according to claim 1,
wherein the data transferring unit specifies a source and destination for the transfer of two or more sets of data, performs the transfer of each set of data in divided portions in sequence, and independently specifies the amount of data to be divided for each set.

10. The information processing device according to claim 9,
wherein the data at the source and the data at the destination are image data.

11. An information processing method of an image processing device, the information processing method comprising:
an external bus connecting unit connects a local memory, a data transferring unit, and a command list processing unit to an external memory;
the data transferring unit transfers data, which are conditions for calculation stored in the external memory to the local memory;
the local memory stores the data and a list of commands;
the command list processing unit reads the list of commands from the local memory and generates a command to execute calculation by a calculation processing unit while transferring data from the external memory to the local memory; and
the calculation processing unit executes calculation and processes the data.

12. The information processing method according to claim 11,
wherein the data transferring unit includes transfer size monitoring unit, and the command list processing unit generates a command to execute calculation by the calculation processing unit when the transfer size monitoring unit detects that the transfer of a unit of data, which can be calculated by the calculation processing unit, from the external memory to the local memory is complete.

13. The information processing method according to claim 11,
wherein the command list processing unit rearranges and links multiple transfer commands, which transfer a size of data greater than a unit that can be calculated by the calculation processing unit e into multiple transfer commands of the same attribute for consecutive addresses within the local memory, issues the transfer commands to request the transfer of data by the external bus connecting unit, and generates a command to execute calculation by the calculation processing unit when the transfer of the required amount of data to the local memory is complete.

14. The information processing method according to claim 11,
wherein the data transferring unit specifies a source and a destination for transferring two or more sets of data, performs transferring of each set of data in divided portions in sequence, and independently specifies the amount of data to be divided for each set.

15. The information processing method according to claim 14,
wherein the data at the source and the data at the destination are image data.
